(19) United States
(12) Patent Application Publication
(10) Pub. No.: US 2013/0236028 A1
(43) Pub. Date: Sep. 12, 2013

(54) DATA PROCESSING METHOD AND ELECTRONIC DEVICE

(71) Applicants: BEIJING LENOVO SOFTWARE LTD., Beijing (CN); LENOVO (BEIJING) LIMITED, Beijing (CN)

(72) Inventors: Yongqiang Zhang, Beijing (CN); Jun Li, Beijing (CN)

(73) Assignees: LENOVO (BEIJING) LIMITED, Beijing (CN); BEIJING LENOVO SOFTWARE LTD., Beijing (CN)

(21) Appl. No.: 13/797,170

(22) Filed: Mar. 12, 2013

(30) Foreign Application Priority Data
Mar. 12, 2012 (CN) 201210063652.0

(51) Int. Cl. H04R 3/12

(52) U.S. Cl. CPC H04R 3/12
USPC 381/80

(57) ABSTRACT

The present invention discloses a data processing method applied in an electronic device. The electronic device includes a codec, at least two audio output devices, an identification module, a communication module and at least two players. The method comprises the steps of: decoding, by the at least two players, at least two paths of coded multi-media data containing audio data to generate at least two channels of code streams corresponding to the at least two paths of multi-media data when the electronic device is in an operating state; assigning, by the identification module, an identifier to each of the at least two channels of code streams and transmitting at least two identifiers to the communication module, the at least two identifiers being provided to the codec such that the codec can receive the at least two channels of code streams based on the at least two identifiers; and establishing, by the codec, a channel corresponding to each of the at least two channels of code streams based on the at least two identifiers, such that each channel of code stream can be output to one of the at least two audio output devices via its corresponding channel.

### CROSS REFERENCE TO RELATED APPLICATIONS

This application claims the benefit and priority of a foreign application filed in China as Application No. 201210063652.0 on Mar. 12, 2012, all of which is incorporated herein by reference.

### TECHNICAL FIELD

The present invention relates to electronic technology, and more particularly, to a data processing method and an electronic device.

### BACKGROUND

With the economic development, our life experiences have been constantly improved. For example, when using electronic devices, we hope that they can have more functions and bring us more fun.

There are currently various electronic devices, such as notebook computers and tablet computers. Taking a tablet computer as an example, when more than one application capable of playing music is running on the tablet computer, all the respective music will be output from these applications.

For example, an tablet computer may be used by multiple users. User A listens to music using the tablet computer. User B watches a movie on the tablet computer. User C plays a game on the tablet computer. User D chats using the QQ application on the tablet computer. In this case, the tablet computer plays using their respective players and outputs respective sounds via a speaker. For example, the music is played in a music player, the movie is played in a movie player and the sounds of the music and the movie are output via the speaker.

In addition, when a headphone is inserted into a headphone jack of the tablet computer, the sounds will be directly output from the headphone instead of the speaker. The headphone and the speaker cannot be used simultaneously.

During the implementation of the present invention, the applicant realizes at least the following technical problem in the prior art: sounds output from different applications are mixed and undistinguishable.

### SUMMARY

An object of the present invention is to provide an electronic device capable of solving the above problem in the prior art that sounds output from different applications are mixed and undistinguishable.

In an aspect, according to a first embodiment of the present invention, a data processing method is provided. The method is applied in an electronic device which includes a codec, at least two audio output devices, an identification module, a communication module and at least two players. The method comprises: decoding, by the at least two players, at least two paths of coded multi-media data containing audio data to generate at least two channels of code streams corresponding to the at least two paths of multi-media data when the electronic device is in an operating state; assigning, by the identification module, an identifier to each of the at least two channels of code streams and transmitting at least two identifiers to the communication module, the at least two identifiers being provided to the codec such that the codec can receive the at least two channels of code streams based on the at least two identifiers; and establishing, by the codec, a channel corresponding to each of the at least two channels of code streams based on the at least two identifiers, such that each channel of code stream can be output to one of the at least two audio output devices via its corresponding channel.

Alternatively, prior to the at least two players decoding at least two paths of coded multi-media data containing audio data, the method further comprises: obtaining, by a data processing module in the electronic device, at least two paths of multi-media data containing audio data; coding, by the data processing module, the at least two paths of multi-media data based on a predetermined coding rule to obtain the at least two paths of coded multi-media data containing audio data; and transmitting the at least two paths of coded multi-media data containing audio data to the at least two players.

Alternatively, the data processing module in the electronic device obtaining at least two paths of multi-media data containing audio data comprises: obtaining, by the data processing module in the electronic device, the at least two paths of multi-media data containing audio data from at least one storage unit in the electronic device; or obtaining, by the data processing module in the electronic device, the at least two paths of multi-media data containing audio data from a data transceiving interface in the electronic device, wherein the data transceiving interface is an interface module for connecting to a network or another device.

Alternatively, the at least two players decoding at least two paths of coded multi-media data containing audio data to generate at least two channels of code streams corresponding to the at least two paths of multi-media data comprises: obtaining, by the at least two players, the at least two paths of coded multi-media data containing audio data; decoding, by the at least two players, the at least two paths of coded multi-media data containing audio data based on a predetermined decoding rule corresponding to the predetermined coding rule to obtain the at least two channels of code streams corresponding to the at least two paths of multi-media data.

Alternatively, the at least two players decoding the at least two paths of coded multi-media data containing audio data based on a predetermined decoding rule corresponding to the predetermined coding rule to obtain the at least two channels of code streams corresponding to the at least two paths of multi-media data comprises: determining, for each of the at least two players, one of the at least two paths of coded multi-media data containing audio data based on a matching relationship between the coded multi-media data and the players; and decoding, by each player, its corresponding path of coded multi-media data containing audio data based on the predetermined decoding rule corresponding to the predetermined coding rule to obtain a corresponding channel of code stream.

Alternatively, each player decoding its corresponding path of coded multi-media data containing audio data based on the predetermined decoding rule corresponding to the predetermined coding rule to obtain a corresponding channel of code stream comprises: decoding, by using a decoding package in each player, its corresponding path of coded multi-media data containing audio data based on the predetermined decoding rule corresponding to the predetermined coding rule to obtain compressed multi-media data containing audio data; and automatically restoring the compressed multi-media data containing audio data to generate the corresponding channel of code stream.

Alternatively, the identification module assigning an identifier to each of the at least two channels of code streams comprises: setting, by the identification module, an identifier at a predetermined location in each of the at least two channels of code streams, wherein the identifier is unique to the channel of code stream.

Alternatively, setting an identifier at a predetermined location in each of the at least two channels of code streams comprises: setting a numerical or alphabetic identifier at the front or back end of each of the at least two channels of code streams.

In another aspect, according to a second embodiment of the present invention, an electronic device is provided. The electronic device comprises: at least two players each containing a decoding package for decoding a code file; an identification module connected to the players; a communication module connected to the identification module; a codec connected to the communication module; at least two audio output devices each connected to the codec. The at least two players decode at least two paths of coded multi-media data containing audio data to generate at least two channels of code streams corresponding to the at least two paths of multi-media data when the electronic device is in an operating state. The identification module assigns an identifier to each of the at least two channels of code streams and transmits at least two identifiers to the communication module, the at least two identifiers being provided to the codec such that the codec can receive the at least two channels of code streams based on the at least two identifiers. The codec establishes a channel corresponding to each of the at least two channels of code streams based on the at least two identifiers, such that each channel of code stream can be output to one of the at least two audio output devices via its corresponding channel.

Alternatively, the electronic device further comprises: a data processing module configured to obtain at least two paths of multi-media data containing audio data, to code the at least two paths of multi-media data based on a predetermined coding rule to obtain the at least two paths of coded multi-media data containing audio data, and to transmit the at least two paths of coded multi-media data containing audio data to the at least two players, before the at least two players decode the at least two paths of coded multi-media data containing audio data.

One or more of the above aspects have at least the following technical effects or advantages.

In a scenario involving interactions with multiple users, an electronic device is automatically activated. Additionally, when processing audio data, the electronic device automatically identifies the audio data with a number of identifiers and assigns code streams channels corresponding to the number of identifiers. In this way, the present invention solves the technical problem that the audio data output from different applications are output from only one code stream channel and thus the sounds are mixed and undistinguishable. With the present invention, it is possible to achieve the technical effect that, when the audio data are output via different code stream channels, the sounds from different applications can be distinguishable without interfering with each other, thereby improving the user experience.

### BRIEF DESCRIPTION OF THE DRAWINGS

FIG. 1 is a flowchart of a data processing method according to a first embodiment of the present invention; and

FIG. 2 is a structural block diagram of an electronic device according to a second embodiment of the present invention.

### DETAILED DESCRIPTION OF THE EMBODIMENTS

The solutions of the present invention will be detailed in the following with reference to the embodiments taken in conjunction with the figures, such that those skilled in the art can have a better understanding of the present invention,

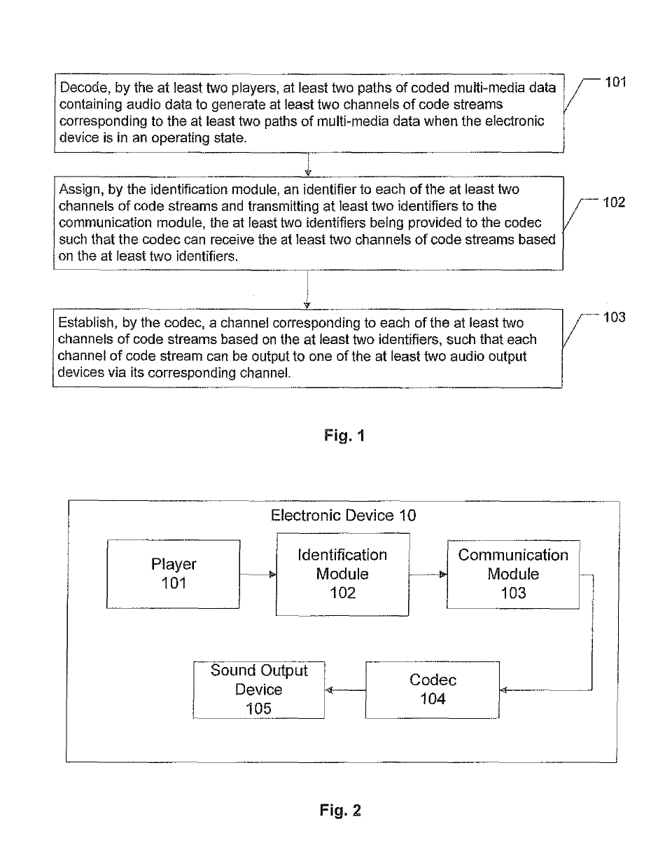

Referring to FIG. 1, a data processing method according to a first embodiment of the present invention is applied in an electronic device which includes a codec, at least two audio output devices, an identification module, a communication module and at least two players. The method comprises the following steps.

At step 101, the at least two players decode at least two paths of coded multi-media data containing audio data to generate at least two channels of code streams corresponding to the at least two paths of multi-media data when the electronic device is in an operating state.

At step 102, the identification module assigns an identifier to each of the at least two channels of code streams and transmits at least two identifiers to the communication module. The at least two identifiers are provided to the codec such that the codec can receive the at least two channels of code streams based on the at least two identifiers.

At step 103, the codec establishes a channel corresponding to each of the at least two channels of code streams based on the at least two identifiers, such that each channel of code stream can be output to one of the at least two audio output devices via its corresponding channel.

In particular, prior to the at least two players decoding at least two paths of coded multi-media data containing audio data, the method further comprises: obtaining, by a data processing module in the electronic device, at least two paths of multi-media data containing audio data; coding, by the data processing module, the at least two paths of multi-media data based on a predetermined coding rule to obtain the at least two paths of coded multi-media data containing audio data; and transmitting the at least two paths of coded multi-media data containing audio data to the at least two players.

In particular, the data processing module in the electronic device obtaining at least two paths of multi-media data containing audio data comprises: obtaining, by the data processing module in the electronic device, the at least two paths of multi-media data containing audio data from at least one storage unit in the electronic device; or obtaining, by the data processing module in the electronic device, the at least two paths of multi-media data containing audio data from a data transceiving interface in the electronic device, wherein the data transceiving interface is an interface module for connecting to a network or another device.

In particular, the at least two players decoding at least two paths of coded multi-media data containing audio data to generate at least two channels of code streams corresponding to the at least two paths of multi-media data comprises: obtaining, by the at least two players, the at least two paths of coded multi-media data containing audio data; decoding, by the at least two players, the at least two paths of coded multi-media data containing audio data based on a predetermined decoding rule corresponding to the predetermined coding rule to obtain the at least two channels of code streams corresponding to the at least two paths of multi-media data.

In particular, the at least two players decoding the at least two paths of coded multi-media data containing audio data based on a predetermined decoding rule corresponding to the predetermined coding rule to obtain the at least two channels of code streams corresponding to the at least two paths of multi-media data comprises: determining, for each of the at least two players, one of the at least two paths of coded multi-media data containing audio data based on a matching relationship between the coded multi-media data and the players; and decoding, by each player, its corresponding path of coded multi-media data containing audio data based on the predetermined decoding rule corresponding to the predetermined coding rule to obtain a corresponding channel of code stream.

In particular, each player decoding its corresponding path of coded multi-media data containing audio data based on the predetermined decoding rule corresponding to the predetermined coding rule to obtain a corresponding channel of code stream comprises: decoding, by using a decoding package in each player, its corresponding path of coded multi-media data containing audio data based on the predetermined decoding rule corresponding to the predetermined coding rule to obtain compressed multi-media data containing audio data; and automatically restoring the compressed multi-media data containing audio data to generate the corresponding channel of code stream.

In particular, the identification module assigning an identifier to each of the at least two channels of code streams comprises: setting, by the identification module, an identifier at a predetermined location in each of the at least two channels of code streams, wherein the identifier is unique to the channel of code stream.

In particular, setting an identifier at a predetermined location in each of the at least two channels of code streams comprises: setting a numerical or alphabetic identifier at the front or back end of each of the at least two channels of code streams.

Next, the data processing method according to the first embodiment of the present invention will be explained in further detail with reference to an example in which the electronic device is a tablet computer. Of course, in practice, the electronic device can also be another type of electronic device.

For example, four users, User A, User B, User C and User D need to use the tablet computer for different applications. User A listens to music using the tablet computer. User B watches a movie on the tablet computer. User C plays a game on the tablet computer. User D chats on the tablet computer. The music, movie, game and chatting tool are all displayed on the display screen of the tablet computer. When the music, movie, game and chatting tool are clicked by User A, User B, User C and User D, respectively, they are loaded into their corresponding applications. At this time, a software system in the tablet computer is automatically activated. The software system includes a data processing module, an identification module, a communication module and a player. When the software system is automatically activated, the number of areas displayed on the display screen matches the number of operating applications. Here, there are four areas displayed on the display screen, denoted as A1, B1, C1 and D1, respectively. Among these areas, the operation state of the music is displayed in Area A1, the operation state of the movie is displayed in Area B1, the operation state of the game is displayed in Area C1 and the operation state of the chatting tool is displayed in Area D1. When operating, all of the music, movie, game and chatting tool produce sounds which will be output by the player.

In an embodiment, the sounds need to be transmitted to the player before the player can play the sounds. In a particular transmission process, the music sound, the movie sound, the game sound and the sound produced by the chatting tool during the chatting will be first obtained by the data processing module in the table computer. In particular, the data processing module obtains these sounds as audio data, compresses the audio data into corresponding code files (e.g., the music sound can be compressed into an MP3 code file and the movie sound can be compressed into an ASF file) and transmits the code files to the player. In practice, there can four players in this embodiment for playing the sounds of music, movie, game and chatting, respectively.

Upon receiving the audio data, the four players use their data decoding packages to decode the code files. After the decoding process, the four players automatically restore the audio data into PCM code streams. In practice, there will be a large number of PCM code streams which can be considered as a group. The PCM code streams are raw sound data received by the four players. After the automatic restoration to obtain the PCM code streams, the four players transmit the PCM code streams to the identification module, which is also a PCM identification module. Since the PCM code streams are generated by the four players in the automatic restoration process, the PCM identification module assigns an identifier to the PCM code streams after receiving the PCM code streams. In particular, the identifier can be a number or an alphabet letter and located at the front or back end of the PCM code streams. For example, the PCM code streams can be identified as PCM1, PCM2, PCM3 and PCM4, denoting the PCM code streams automatically restored by the four players, respectively.

After identifying the automatically restored PCM code streams, the PCM identification module transmits the identified PCM code streams to the communication module. When communicating with the codec, the communication module transmits the identified PCM code streams to the codec. Upon receiving the identified PCM code streams, the codec assigns a number of code stream channels corresponding to the number of identifiers. Here, there can be four code stream channels, denoted as channel1, channel2, channel3 and channel4, respectively. In particular, each of the four code stream channels only receives the PCM code stream having the corresponding identifiers. For example, the channel1 receives only data in PCM1, the channel2 receives only data in PCM2, the channel3 receives only data in PCM3 and the channel4 receives only data in PCM4. Since the data in PCM1, PCM2, PCM3 and PCM4 are transmitted to the codec in digital form, the codec uses its Digital-to-Analog Converter (DAC) to convert the digital signals of the data in PCM1, PCM2, PCM3 and PCM4 into analog signals after receiving the data in PCM1, PCM2, PCM3 and PCM4. In a particular conversion process, the data processing for the PCM data in the channel1, channel2, channel3 and channel4 is independent of each other.

In an embodiment, after converting the data in PCM1, PCM2, PCM3 and PCM4 into analog signals, the codec transmits the analog signals to audio output devices, such as headphones. Here, the number of headphones corresponds to the number of players. In other words, there are four headphones, denoted as Headphone1, Headphone2, Headphone3 and Headphone4, respectively. Here, the analog signals received by the headphones correspond to the analog signals output from the respective code stream channels one by one. In particular, Headphone1 receives the analog signal output from the channel1, Headphone2 receives the analog signal output from the channel2, Headphone3 receives the analog signal output from the channel3 and Headphone4 receives the analog signal output from the channel4.

In an embodiment, each headphone corresponds to a user. For example, User A, User B, User C and User D wear Headphone1, Headphone2, Headphone3 and Headphone4, respectively. Each user can clearly hear his/her desired sound without interfering with the other sounds. In particular, User A can hear the music sound via Headphone1, User B can hear the movie sound via Headphone2, User C can hear the game sound via Headphone3 and User D can hear the chatting sound via Headphone4.

Referring to FIG. 2, an electronic device 10 according to a second embodiment of the present invention includes: at least two players 101 each containing a decoding package for decoding a code file; an identification module 102 connected to the players 101; a communication module 103 connected to the identification module 102; a codec 104 connected to the communication module 103; at least two audio output devices 105 each connected to the codec 104.

The at least two players 101 decode at least two paths of coded multi-media data containing audio data to generate at least two channels of code streams corresponding to the at least two paths of multi-media data when the electronic device 10 is in an operating state. The identification module 102 assigns an identifier to each of the at least two channels of code streams and transmits at least two identifiers to the communication module 103. The at least two identifiers are provided to the codec 104 such that the codec 104 can receive the at least two channels of code streams based on the at least two identifiers. The codec 104 establishes a channel corresponding to each of the at least two channels of code streams based on the at least two identifiers, such that each channel of code stream can be output to one of the at least two audio output devices 105 via its corresponding channel.

The electronic device further includes: a data processing module configured to obtain at least two paths of multi-media data containing audio data, to code the at least two paths of multi-media data based on a predetermined coding rule to obtain the at least two paths of coded multi-media data containing audio data, and to transmit the at least two paths of coded multi-media data containing audio data to the at least two players 101, before the at least two players decode the at least two paths of coded multi-media data containing audio data.

One or more of the above embodiments have at least the following technical effects or advantages.

In a scenario involving interactions with multiple users, an electronic device is automatically activated. Additionally, when processing audio data, the electronic device automatically identifies the audio data with a number of identifiers and assigns code streams channels corresponding to the number of identifiers. In this way, the present invention solves the technical problem that the audio data output from different applications are output from only one code stream channel and thus the sounds are mixed and undistinguishable. With the present invention, it is possible to achieve the technical effect that, when the audio data are output via different code stream channels, the sounds from different applications can be distinguishable without interfering with each other, thereby improving the user experience.

Obviously, those skilled in the art can make various modifications and variants of the present invention without departing from the spirit and scope of the present invention. These modifications and variants are to be encompassed by the scope of the present invention if they fall into the scope of the claims and their equivalents.

What is claimed is:

1. A data processing method, applied in an electronic device which comprises a codec, at least two audio output devices, an identification module, a communication module and at least two players, the method comprising:
decoding, by the at least two players, at least two paths of coded multi-media data containing audio data to generate at least two channels of code streams corresponding to the at least two paths of multi-media data when the electronic device is in an operating state;
assigning, by the identification module, an identifier to each of the at least two channels of code streams and transmitting at least two identifiers to the communication module, the at least two identifiers being provided to the codec such that the codec can receive the at least two channels of code streams based on the at least two identifiers; and
is establishing, by the codec, a channel corresponding to each of the at least two channels of code streams based on the at least two identifiers, such that each channel of code stream can be output to one of the at least two audio output devices via its corresponding channel.

2. The method of claim 1, further comprising, prior to the at least two players decoding at least two paths of coded multi-media data containing audio data:
obtaining, by a data processing module in the electronic device, at least two paths of multi-media data containing audio data;
coding, by the data processing module, the at least two paths of multi-media data based on a predetermined coding rule to obtain the at least two paths of coded multi-media data containing audio data; and
transmitting the at least two paths of coded multi-media data containing audio data to the at least two players.

3. The method of claim 2, wherein the data processing module in the electronic device obtaining at least two paths of multi-media data containing audio data comprises:
obtaining, by the data processing module in the electronic device, the at least two paths of multi-media data containing audio data from at least one storage unit in the electronic device; or
obtaining, by the data processing module in the electronic device, the at least two paths of multi-media data containing audio data from a data transceiving interface in the electronic device, wherein the data transceiving interface is an interface module for connecting to a network or another device.

4. The method of claim 1, wherein the at least two players decoding at least two paths of coded multi-media data containing audio data to generate at least two channels of code streams corresponding to the at least two paths of multi-media data comprises:
obtaining, by the at least two players, the at least two paths of coded multi-media data containing audio data;
decoding, by the at least two players, the at least two paths of coded multi-media data containing audio data based on a predetermined decoding rule corresponding to the predetermined coding rule to obtain the at least two channels of code streams corresponding to the at least two paths of multi-media data.

5. The method of claim 4, wherein the at least two players decoding the at least two paths of coded multi-media data containing audio data based on a predetermined decoding rule corresponding to the predetermined coding rule to obtain the at least two channels of code streams corresponding to the at least two paths of multi-media data comprises:
determining, for each of the at least two players, one of the at least two paths of coded multi-media data containing audio data based on a matching relationship between the coded multi-media data and the players; and
decoding, by each player, its corresponding path of coded multi-media data containing audio data based on the predetermined decoding rule corresponding to the predetermined coding rule to obtain a corresponding channel of code stream.

6. The method of claim 5, wherein each player decoding its corresponding path of coded multi-media data containing audio data based on the predetermined decoding rule corresponding to the predetermined coding rule to obtain a corresponding channel of code stream comprises:
decoding, by using a decoding package in each player, its corresponding path of coded multi-media data containing audio data based on the predetermined decoding rule corresponding to the predetermined coding rule to obtain compressed multi-media data containing audio data; and
automatically restoring the compressed multi-media data containing audio data to generate the corresponding channel of code stream.

7. The method of claim 1, wherein the identification module assigning an identifier to each of the at least two channels of code streams comprises:
setting, by the identification module, an identifier at a predetermined location in each of the at least two channels of code streams,
wherein the identifier is unique to the channel of code stream.

8. The method of claim 7, wherein setting an identifier at a predetermined location in each of the at least two channels of code streams comprises:
setting a numerical or alphabetic identifier at the front or back end of each of the at least two channels of code streams.

9. An electronic device, comprising:
at least two players each containing a decoding package for decoding a code file;
an identification module connected to the players;
a communication module connected to the identification module;
a codec connected to the communication module; and
at least two audio output devices each connected to the codec;
wherein the at least two players decode at least two paths of coded multi-media data containing audio data to generate at least two channels of code streams corresponding to the at least two paths of multi-media data when the electronic device is in an operating state;
the identification module assigns an identifier to each of the at least two channels of code streams and transmits at least two identifiers to the communication module, the at least two identifiers being provided to the codec such that the codec can receive the at least two channels of code streams based on the at least two identifiers; and
the codec establishes a channel corresponding to each of the at least two channels of code streams based on the at least two identifiers, such that each channel of code stream can be output to one of the at least two audio output devices via its corresponding channel.

10. The electronic device of claim 9, further comprising:
a data processing module configured to obtain at least two paths of multi-media data containing audio data, to code the at least two paths of multi-media data based on a predetermined coding rule to obtain the at least two paths of coded multi-media data containing audio data, and to transmit the at least two paths of coded multi-media data containing audio data to the at least two players, before the at least two players decode the at least two paths of coded multi-media data containing audio data.
